(19) United States
(12) Patent Application Publication
(10) Pub. No.: US 2002/0024444 A1
(43) Pub. Date: Feb. 28, 2002

(54) Safe driving support system and method for same

(75) Inventors: Satoshi Hiyama, Wako-shi (JP); Ryoji Igarashi, Wako-shi (JP); Hiroshi Uematsu, Wako-shi (JP); Takashi Sugawara, Wako-shi (JP); Kenichi Tohya, Wako-shi (JP); Jun Ashihara, Wako-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: HONDA GIKEN KOGYO KABUSHIKI KAISHA

(21) Appl. No.: 09/935,626

(22) Filed: Aug. 24, 2001

(30) Foreign Application Priority Data
Aug. 25, 2000 (JP) P2000-256409

(51) Int. Cl. B60Q 1/00

(52) U.S. Cl. 340/576; 340/436

(57) ABSTRACT

There is provided a safe driving support system that is able to give accurate and appropriate advice to a driver based on the driving conditions at the time the vehicle is actually being driven. A driving conditions collection device receives operation data representing a driving operation and vehicle data representing the behavior of a vehicle and collects these data. A driving trend determination device performs an analysis and makes a determination based on this collected data and extracts any unsafe phenomena. A presentation device then reads, as contents that correspond to the unsafe phenomena in the driving conditions, advice information relating to driving from contents data that have been stored in advance. This advice information is then presented to the driver.

### BACKGROUND OF THE INVENTION

1. Field of the Invention

The present invention relates to a safe driving support system for providing the driver of a vehicle with advice relating to safe driving.

2. Description of the Related Art

Conventionally, adaptive cruise control devices, vehicle deviation prevention devices and the like have been used for in-vehicle systems designed to increase the level of safety of a driven vehicle. These devices take care of a part of the operation by the driver to drive the vehicle so as to control the running of the vehicle. For example, the above devices control the operations of the accelerator throttle and the steering automatically when traveling on an expressway so that the driver does not have to perform these tasks him or her self.

However, the above devices are intended to make a part of the driver's tasks unnecessary and the driving skill of the driver is not improved at all by these devices. Naturally, each driver completes a set training course in order to obtain a driver's license and possesses certain driving skills at that point, however, in many cases, a driver has no chance to receive accurate and appropriate advice for further improving his or her driving skills after he or she has obtained a driver's license. In order for a driver to drive safely, it would be beneficial if the driver were able to obtain advice that was appropriate to the actual driving conditions and the mounting in vehicles of a system for providing such advice is desired.

### SUMMARY OF THE INVENTION

The present invention was conceived in view of the above circumstances and it is an aim thereof to provide a safe driving support system that is capable of giving accurate and appropriate advice to a driver based on the driving conditions existing at the time the vehicle is actually being driven.

In order to solve the above problem, the safe driving support system of the present invention comprises: a driving conditions collection device for collecting operation data representing driving operations by a driver of a vehicle and vehicle data representing the behavior of the vehicle; a driving trend determination device for determining driving trends of the driver based on the vehicle data and the operation data collected by the driving conditions collection device; and a presentation device for reading and displaying contents data that corresponds with the determined driving trends.

Moreover, the safe driving support method of the present invention comprises: a step in which operation data representing driving operations by a driver of a vehicle and vehicle data representing the behavior of the vehicle are collected; a step in which driving trends of the driver are determined based on the vehicle data and the operation data; a step in which unsafe phenomena are extracted based on the driving trends; a step in which contents data that corresponds to the extracted unsafe phenomena is read; and a step in which the contents data is displayed.

Furthermore, on the recording medium capable of being read by a computer of the present invention there is recorded a program for executing on a computer a process comprising: a step in which operation data representing driving operations by a driver of a vehicle and vehicle data representing the behavior of the vehicle are collected; a step in which driving trends of the driver are determined based on the vehicle data and the operation data; a step in which unsafe phenomena are extracted based on the driving trends; a step in which contents data that corresponds to the extracted unsafe phenomena is read; and a step in which the contents data is displayed.

According to the present invention, a driving conditions collection device collects operation data relating to driving operations and vehicle data relating to vehicle behavior; a driving trends determination device determines driving trends characteristic of a particular driver based on the above data; and contents that correspond to the results of the determination are presented to the driver in the form of advice or the like for encouraging safe driving. As a result, the driver is able to receive information that corresponds to his or her own driving pattern and this information can be linked to an improvement in the driving skills of that driver.

### BRIEF DESCRIPTION OF THE DRAWINGS

FIG. 1 is a block diagram showing the structure of the safe driving support system according to the first embodiment of the present invention.

FIG. 2 is a flow chart showing the processing procedure of the safe driving support system according to the first embodiment.

FIG. 3 is a diagram for reference showing an example of circumstances surrounding a traveling vehicle.

FIG. 4 is a graph showing an example of a desirable transformation state between the distance traveled and the vehicle speed when a vehicle is decelerating to stop.

FIG. 5 is a block diagram showing the structure of the safe driving support system according to the second embodiment of the present invention.

FIG. 6 is a block diagram showing the structure of the safe driving support system according to the third embodiment of the present invention.

### DETAILED DESCRIPTION OF THE PREFERRED EMBODIMENTS

The respective embodiments of the present invention will now be described with reference made to the drawings.

### First Embodiment

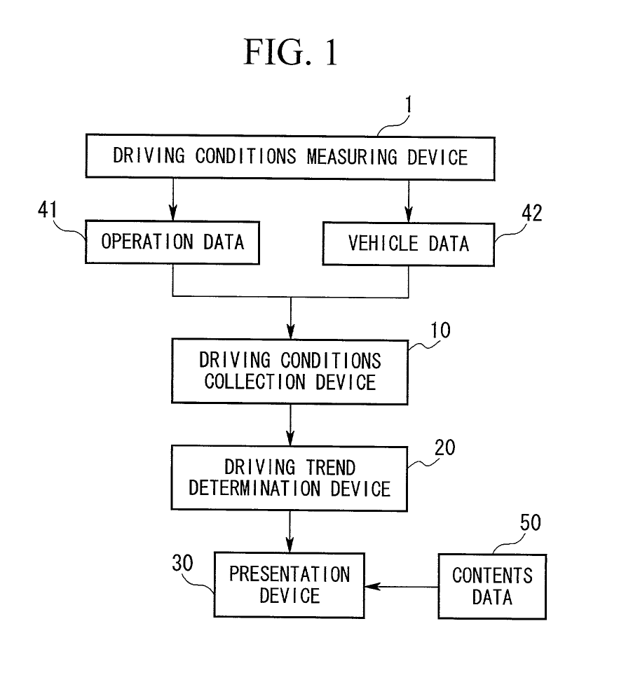

FIG. 1 is a block diagram showing the structure of the safe driving support system according to the first embodiment of the present invention. In FIG. 1 the symbol 1 indicates a driving conditions measuring device formed from various types of sensors, measuring instruments, and the like. The driving conditions measuring device 1 outputs operation data 41 and vehicle data 42 that are described below. The symbol 10 indicates a driving conditions collection device for collecting driving conditions data based on the operation data 41 and the vehicle data 42 sent from the driving conditions measuring device 1. The symbol 20 indicates a driving trend determination device for analyzing and determining driving trends based on the driving conditions data collected by the driving conditions collection device 10. The symbol 50 indicates contents data that includes the contents of advice as to what the driver should do in order to be able to drive safely in accordance with the driving trends. The symbol 30 indicates a presentation device for reading from the contents data 50 the contents of advice appropriate to the driving trends based on the driving trends determined by the driving trend determination device 20 and then presenting these contents to the driver.

The symbols 41 and 42 indicate respectively operation data and vehicle data collected by the driving conditions collection device 10. The operation data 41 is data representing the contents of the driving operation by the driver and includes, for example, the depression angle of the accelerator throttle, the brake pressure, the steering wheel turn angle, and the like. The vehicle data 42 is data representing the behavior of the vehicle and includes, for example, the vehicle speed, the yaw rate, the vehicle acceleration, the distance to the vehicle traveling in front, and the like.

The driving trend determination device 20 analyzes the driving trends on the basis of data such as that described above collected by the driving conditions collection device 10 and determines whether or not there are any unsafe phenomena. Specifically, the term driving trends refers, for example, to fluctuations in the vehicle speed, the distance between the vehicles when following a vehicle traveling in front, the cornering speed when moving round a corner, the acceleration from standstill, the deceleration rate and procedure when decelerating to stop, and the like.

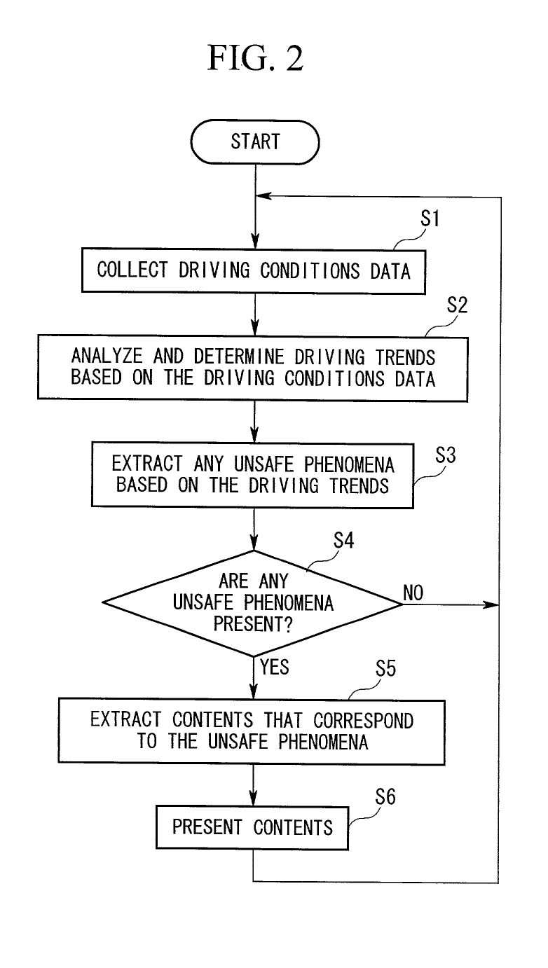

Next, a description will be given of the operational procedure of this safe driving support system. FIG. 2 is a flow chart showing the operational procedure of the safe driving support system. Firstly, in step S1 in FIG. 2, the driving conditions collection device 10 collects driving conditions data (namely, the operation data 41 and the vehicle data 42). Next, in step S2, the driving trend determination device 20 analyzes and determines the driving trends based on the above driving conditions data and decides whether or not unsafe phenomena are present. Next, in step S3, the driving trend determination device 20 attempts to extract the unsafe phenomena in the driving trends. Next, in step S4, if there are no unsafe phenomena, the routine returns to step S1 and the collecting of the driving conditions data is continued. In step S4, if there are unsafe phenomena, the routine moves to the next step S5 and the presentation device 30 extracts contents that correspond to the unsafe phenomena from the contents data 50. Next, in step S6, the contents extracted by the presentation device 30, namely, advice information appropriate to a particular driver, is presented to that driver.

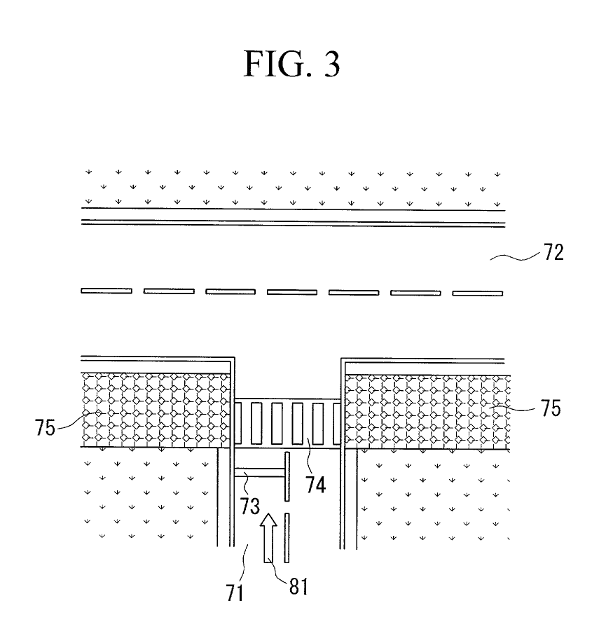

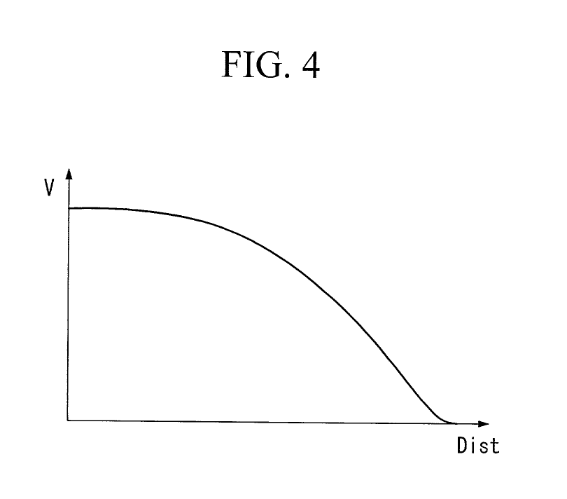

Here, a description will be given of specific unsafe phenomena. FIG. 3 is a diagram for reference showing an example of the circumstances of a vehicle decelerating to stop. In the circumstances shown in FIG. 3, a T-intersection is formed by the road 71 and the road 72. A pedestrian footpath 75 is provided running alongside the road 72. In addition, a pedestrian crossing 74 is provided crossing the road 71 and running parallel with the road 72. Furthermore, a stop line 73 is provided in front of the pedestrian crossing 74 in the lane for vehicles that are entering the road 72 from the road 71 (i.e. that are traveling in the direction of the arrow 81). In circumstances such as these, there are cases when it is difficult from a vehicle traveling in the direction of the arrow 81 to see vehicles coming along the road 72 or pedestrians walking along the footpath 75. If, in such cases, the manner in which the vehicle is decelerating to stop is inappropriate, then it is possible that the driver will not be able to respond satisfactorily, for example, to a pedestrian suddenly walking out onto the road. As a safe driving method for approaching this type of T-intersection, it is desirable that the vehicle approaches the T-intersection while decelerating a sufficient distance beforehand, comes to a complete stop temporarily in front of the stop line 73, and only enters the road 72 after verifying that there are no pedestrians crossing the pedestrian footpath 75. In such cases, the desirable state of transformation (see FIG. 4) between the vehicle speed (the vertical axis V) and the distance traveled (the horizontal axis Dist) that takes a position a set distance in front of the stop line 73 as a reference point is stored in advance internally in the driving trend determination device 20. The driving trend determination device 20 determines whether or not the state of transformation between the vehicle speed and distance traveled determined from the vehicle data 42 and the operation data 41 collected by the driving conditions collection device 10 is deviating from the state of transformation shown in FIG. 4. This enables the driving trend determination device 20 to determine whether or not there are unsafe phenomena present. If the driver is not driving in a safe manner, as described above, and the driving trend determination device 20 determines that there are unsafe phenomena present, the classification of the unsafe phenomena is transmitted to the presentation device 30. The presentation device 30 then presents, for example, advice relating to safe driving when approaching a T-intersection or an explanation concerning examples of previous accidents that occurred at T-intersections in similar circumstances.

Note that, in the present embodiment, the driving conditions measuring device 1, the driving conditions collection device 10, the driving trend determination device 20, the presentation device 30, and the contents data 50 are all mounted in the vehicle as an integrated system. Specifically, the presentation device 30 is a display screen or voice generating device or both of these together mounted in the vehicle that presents contents to the driver when the vehicle is stopped.

Moreover, it is also possible for the present invention to have a structure such as that described in each of the embodiments below.

### Second Embodiment

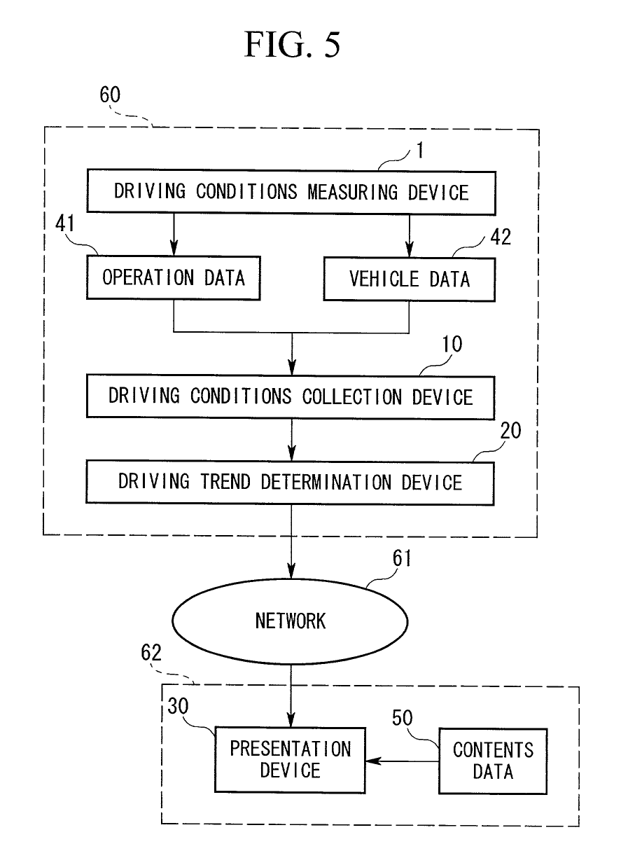

FIG. 5 is a block diagram showing the structure of the safe driving support system according to the present embodiment. Note that those structural elements that are the same as those shown in FIG. 1 are given the same descriptive symbols. In the second embodiment, the driving conditions measuring device 1, the driving conditions collection device 10, and the driving trend determination device 20 are mounted in the vehicle 60 and the results of the determinations made by the driving trend determination device 20 are transmitted to a data center 62 by electronic communication (for example, communication via a network 61 such as a mobile telephone network, an inter-vehicular communications device, or the Internet). The contents data 50 and the presentation device 30 are provided in the data center 62 and when not driving the driver is able to access the presentation device 30 via a two-way television, a web site on the Internet or the like and can receive a display of contents that are based on the driver's own driving conditions. Note that, when accessing the two-way television, the web site on the Internet or the like, the data center 62 performs an authentication process for the purposes of identifying the driver.

### Third Embodiment

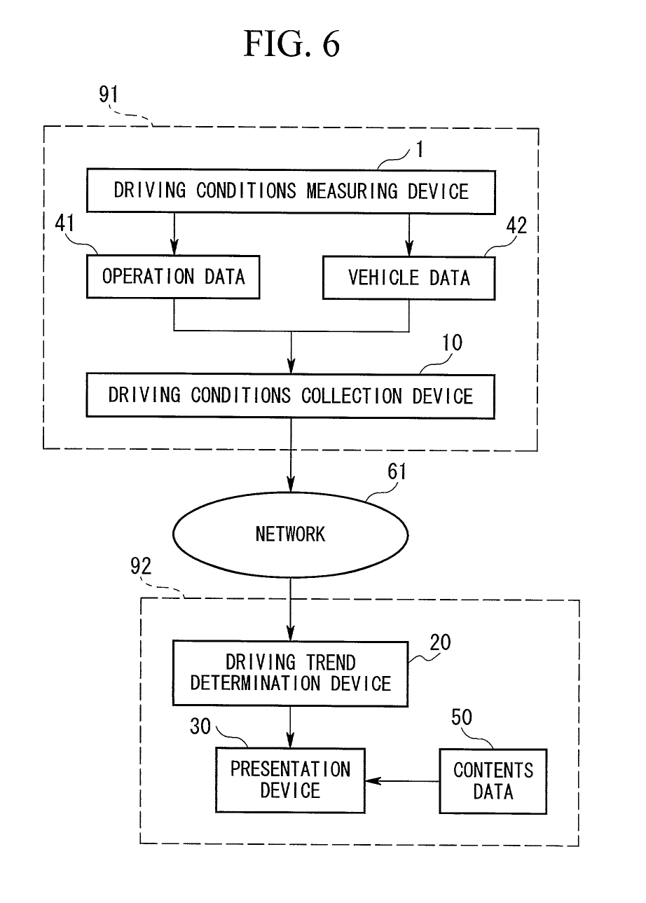

FIG. 6 is a block diagram showing the structure of the safe driving support system according to the present embodiment. Note that those structural elements that are the same as those shown in FIG. 1 or FIG. 5 are given the same descriptive symbols. In the third embodiment, the driving conditions measuring device 1 and the driving conditions collection device 10 are mounted in the vehicle 91 and the data collected by the driving conditions collection device 10 is transmitted to a data center 92 by communication such as that described above via the network 61. The driving trend determination device 20, the contents data 50, and the presentation device 30 are provided in the data center 92 and, as described above, the driver is able to access the presentation device 30 via a two-way television, a web site on the Internet or the like and can receive a display of contents.

### Variant Examples

It is also possible to form the safe driving support system as is shown in FIG. 1 using forms other than those in the respective embodiments described above.

For example, the above described safe driving support system may be achieved using a computer provided inside the system. In this case, the operation data 41 and the vehicle data 42 are fetched into the computer via an input port as electrical signals. A process including each of the above steps, namely, the collection of the driving conditions, the determination of the driving trends, and the presentation (see the flow chart in FIG. 2) is stored in the form of a program on a recording medium capable of being read by a computer. When the computer then reads and executes this program, the above described processing is performed. Here, the recording medium capable of being read by a computer may be formed from a flexible disk, a magneto-optical disk, a CD (compact disk)-ROM (read only memory), a DVD (digital video disk)-ROM, a magnetic hard disk, semiconductor memory, or the like.

What is claimed is:

1. A safe driving support system, comprising:
a driving conditions collection device for collecting operation data representing driving operations by a driver of a vehicle and vehicle data representing the behavior of the vehicle;
a driving trend determination device for determining driving trends of the driver based on the vehicle data and the operation data collected by the driving conditions collection device; and
a presentation device for reading and displaying contents data that corresponds with the determined driving trends.

2. The safe driving support system according to claim 1, wherein the driving conditions collection device, the driving trend determination device, and the presentation device are all mounted in a vehicle.

3. The safe driving support system according to claim 1, wherein the driving conditions collection device and the driving trend determination device are both mounted in a vehicle and the presentation device is installed in a center connected via a network to the vehicle.

4. The safe driving support system according to claim 1, wherein the driving conditions collection device is mounted in a vehicle and the driving trend determination device and the presentation device are both installed in a center connected via a network to the vehicle.

5. A safe driving support method comprising:
a step in which operation data representing driving operations by a driver of a vehicle and vehicle data representing the behavior of the vehicle are collected;
a step in which driving trends of the driver are determined based on the vehicle data and the operation data;
a step in which unsafe phenomena are extracted based on the driving trends;
a step in which contents data that corresponds to the extracted unsafe phenomena is read; and
a step in which the contents data is displayed.

6. A recording medium capable of being read by a computer on which is recorded a program for executing on a computer a process comprising:
a step in which operation data representing driving operations by a driver of a vehicle and vehicle data representing the behavior of the vehicle are collected;
a step in which driving trends of the driver are determined based on the vehicle data and the operation data;
a step in which unsafe phenomena are extracted based on the driving trends;
a step in which contents data that corresponds to the extracted unsafe phenomena is read; and
a step in which the contents data is displayed.
